(19) United States
(12) Patent Application Publication
(10) Pub. No.: US 2024/0281853 A1
(43) Pub. Date: Aug. 22, 2024

(54) COLLABORATIVE FUNDRAISERS

(71) Applicant: Meta Platforms, Inc., Menlo Park, CA (US)

(72) Inventors: Francesco Fogu, Tiburon, CA (US); Lauren Wong, San Francisco, CA (US); Andrew Bower, Sacramento, CA (US); Jizhi Hu, Palo Alto, CA (US); Cristina Foung, Palo Alto, CA (US); Levi Gemmell, Pleasanton, CA (US)

(21) Appl. No.: 17/643,658

(22) Filed: Dec. 10, 2021

(51) Int. Cl. G06Q 30/02; G06Q 50/00; H04L 51/52

(52) U.S. Cl. CPC G06Q 30/0279; G06Q 50/01; H04L 51/52

(57) ABSTRACT

Techniques are described for a social networking system to provide a collaborative fundraising event that allow for multiple organizers of the event to publish, receive attribution, and edit fundraiser content. In some cases, the social networking system may be configured to distribute the fundraiser content based on metrics, support, and relationships between organizers and other users of the social networking system.

### BACKGROUND

Social networking systems provide users with functionality to share content with other users. Most conventional social networking systems provide sharing in a one to many relationship via a user's account or page. However, in some cases, such as fundraisers, having individual users share collaborative content via duplicate posts generates complexity for the users and increases resource consumption of the social networking system. Therefore, many users may be discouraged from promoting, engaging, and otherwise participating in conventional fundraising events via social network systems.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example system for hosting collaborative fundraiser events on a social networking system, according to some implementations.

FIG. 2 illustrates another example system for hosting collaborative fundraiser events on a social networking system, according to some implementations.

FIG. 3 illustrates yet another example system for hosting collaborative fundraiser events on a social networking system, according to some implementations.

FIG. 4 illustrates yet another example system for hosting collaborative fundraiser events on a social networking system, according to some implementations.

FIG. 5 illustrates yet another example system for hosting collaborative fundraiser events on a social networking system, according to some implementations.

FIG. 6 illustrates example interfaces associated with creating a collaborative fundraiser event according to some implementations.

FIG. 7 illustrates example interfaces associated with accepting an invitation to join a collaborative fundraiser event as an organizer according to some implementations.

FIG. 8 illustrates example interfaces associated with a collaborative fundraiser event according to some implementations.

FIG. 9 illustrates an example interface presented via a computing device associated with an organizer of a collaborative fundraiser event according to some implementations.

FIG. 10 illustrates example interfaces associated with organizer notification and recognition associated with a collaborative fundraising event receiving contributions or support via the social networking system according to some implementations.

FIG. 11 illustrates example interfaces associated with providing recognition for contributions to or support of a collaborative fundraising event according to some implementations.

FIG. 12 illustrates example interfaces associated with a recognition response associated with a collaborative fundraising event according to some implementations.

FIG. 13 is a flow diagram illustrating an example process for inviting organizers to participate in a collaborative fundraising event according to some implementations.

FIG. 14 is a flow diagram illustrating an example process for notifying organizers in regard to donations and other support associated with a collaborative fundraising event according to some implementations.

FIG. 15 is a flow diagram illustrating an example process for assisting organizers in providing recognition for donations to or support of a collaborative fundraising event according to some implementations.

FIG. 16 is an example system and device that is usable to implement the techniques described herein according to some implementations.

### DETAILED DESCRIPTION

Social networking systems and websites are often used to share content associated with events, occasions, projects, and the like, such as fundraisers and/or other charity related endeavors. Often, the content and participation in a fundraiser is attributable to multiple individuals and/or users of the social networking system. However, in conventional systems, often only a single user or organizer may post, upload, or otherwise add content to the fundraiser post or page. Similarly, in the conventional systems, only the organizer may review the support or other feedback and accept funds or other donations on behalf of the beneficiary, often requiring all content associated with the fundraiser posted by other users to redirect or otherwise point towards a location on the social networking system associated with the original post or content. In some cases, such as during a successful fundraising event, the single organizer may be overwhelmed resulting in the user sharing login credentials or other unsecure and potential disruptive offline behaviors.

The social networking system, discussed herein, may allow a user to create and manage a collaborative fundraiser via the social networking system. The collaborative fundraiser event may allow for multiple organizers as well as beneficiaries of the event to create and/or post content associated with the event, share in attribution for contributing to the event, as well as view, consume, and reply to feedback, metrics, and/or comments associated with the event. In this manner, the social networking system, discussed herein, may reduce computational and network resources associated with managing a fundraiser event via the social networking system, increase engagement and responsiveness of users of the social networking system with regard to the fundraiser, and, ultimately, improve the donor response to the fundraiser, furthering the mission of the beneficiary.

In some examples, the social networking system may be configured to allow users to create, share, and interact with a collaborative fundraiser event (e.g., collaborative fundraiser). In some cases, the collaborative fundraiser may have multiple organizers or users that are associated therewith. In some cases, a primary user or original user may create a collaborative fundraiser and invite co-organizers to post, share, reply, and/or otherwise interact with content associated with the collaborative fundraiser.

In some cases, the collaborative fundraiser event (such as a home page or the individual content) may be published with and include attribution to each user account associated with the organizer(s) (e.g., the associated user(s)) and distributed to users that have permissions to view content associated with the individual organizers. Users that have permissions may include other users of the social networking system that are connected to the individual organizers (e.g., users that have “followed” or “liked” a user account of an organizer), or otherwise have permissions to view content published by one or more organizers (e.g., organizer has a public account that is viewable by other users that are not blocked or otherwise restricted from viewing the content). The social networking system may also be configured to distribute notifications of support for the collaborative fundraiser to one or more of the organizers based on, for instance, a type of support (e.g., comment, a like, a notification, etc.), the content of a post, a relationship between the user generating the support and the individual organizers, and the like. For instance, a post or content associated with the collaborative fundraiser event may be distributed to each of the users following or otherwise associated with each of the individual organizers. In other cases, the post or content associated with the fundraiser event may be distributed to a subset of the users following each of the individual organizers.

As an illustrative example, a primary organizer or user may create, upload, and/or post the collaborative fundraiser to the social networking system. During the creation process, the primary organizer may indicate one or more individual users to associate with the collaborative fundraiser via a selectable option or icon. The social networking system may then invite each of the additional user(s) (e.g., send an invitation to user accounts associated with the additional user(s)) to participate in the fundraiser as an organizer. In some cases, individual users may also request authorization from one or more of the organizers to participate either as an organizer or other type of contributor (e.g., a user account listed as contributing to the fundraiser event but with less than full permissions).

Each invited user may then either accept, reject, or ignore (e.g., an effective rejection) the invitation to participate as an organizer of the collaborative fundraiser event. Based on a determination that an invited user rejects the invitation, the social networking system may remove an association of the collaborative fundraiser event from a user account associated therewith. In this manner, a user may prevent an association with a fundraiser the user does not themselves endorse or otherwise support. However, if the user accepts the invitation, the social networking system may associate the user with the collaborative fundraiser (e.g., as an organizer or contributor as indicate in the invitation). In some cases, the accepting user may be listed together with the primary organizer with respect to areas of the collaborative fundraiser that provide attribution to the organizers. For example, an icon and/or user account name of the primary organizer and the accepting organizer(s) may be displayed in conjunction with the content associated with the collaborative fundraiser when another user (e.g., a consuming user) is viewing, streaming, or otherwise accessing the content.

The social networking system may also publish the content associated with the collaborative fundraiser to the user accounts of both the primary organizer and the collaborating organizer that accepted the invitation regardless of the user that created or uploaded the individual content item. In this manner, the content associated with the fundraiser is visible or otherwise available to users accessing or otherwise viewing each of the individual organizers' content or user account.

The social networking system may also generate notifications and/or otherwise distribute the content associated with the collaborative fundraiser to users of the social networking system that have indicated an interest in content associated with one or more of the organizers (e.g., view a profile or media feed associated with an organizer) or have otherwise followed one or more organizers. For example, if a content item is associated with the collaborative fundraiser by a first organizer, the social networking system may distribute the content to individual users that follow a second organizer and/or the third organizer. In some cases, the social networking system may filter the set of users receiving a distribution of the content associated with the collaborative fundraiser, such that each receiving user only receives a single instance of a notification related to and/or the content. For instance, if a receiving user has indicated an interest in the content associated with both the first organizer and the second organizer, the social networking system may add the receiving user to the set of users a single time. In this manner, the social networking system may reduce congestion on the social networking system, computation resource consumption, and/or network resource consumption.

The social networking system may also manage support associated with the content associated with the collaborative fundraiser. For example, the social networking system may allow each of the organizers to access metrics, statistics, comments, and the like of the content associated with the collaborative fundraiser. In some cases, the social networking system may limit or otherwise select one or more of the organizers to receive notifications, alerts, and/or respond to the support. In this manner, the social networking system may limit the number of responses to support from the organizers (e.g., both the first user and the second user responding to the same support), thereby again reducing congestion on the social networking system, computation resource consumption, and/or network resource consumption. In some cases, the social networking system may select one or more of the organizers based at least in part on a relationship of the user providing support to each of the collaborators (e.g., the social networking system selects the user connected to or in a relationship with the user providing support), an amount of interaction between the collaborators and the collaborative content (e.g., the more active or engaged collaborator is selected), a number of interactions between followers of a collaborator and the content (e.g., an interest of the followers), a status of each organizer with respect to the fundraiser and/or the social networking system, and the like.

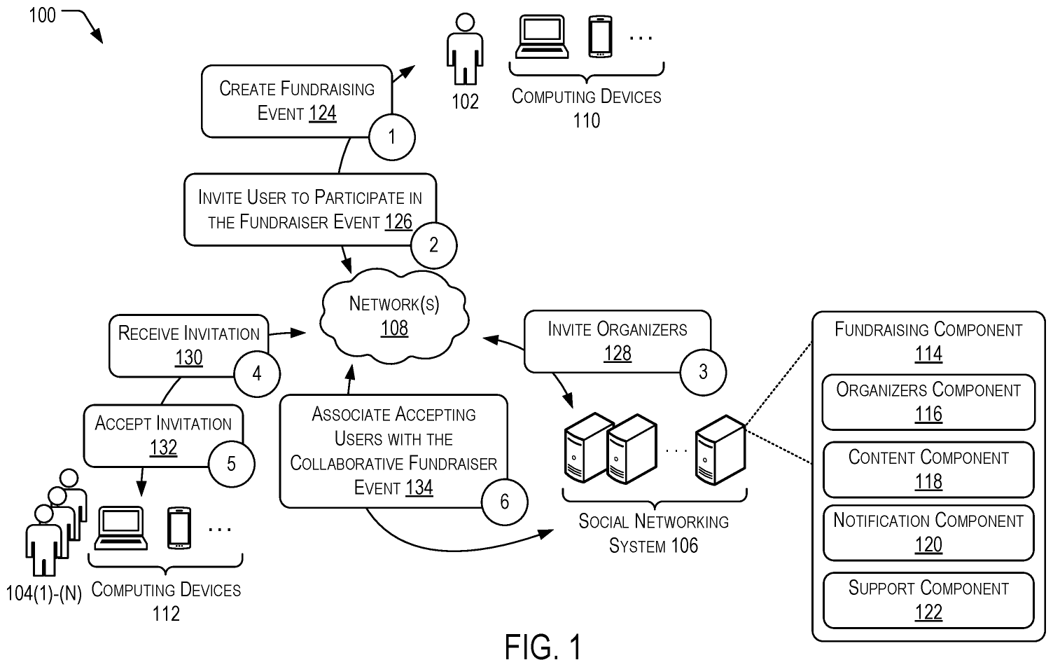

FIG. 1 illustrates an example system 100 for hosting collaborative fundraiser events on a social networking system 106, according to some implementations. In some examples, the system 100 may include a primary user or organizer 102 that may be an original creator of a collaborative fundraiser with respect to the social networking system 106, as well as other users or organizers 104(1)-104(N) (collectively “users 104”) invited by, for instance, the primary organizer 102 to contribute to the collaborative fundraiser. The organizers 102 and 104 may interact with a social networking system 106 via a network 108 using computing devices, generally indicated by 110 and 112, respectively.

In the illustrated example, the social networking system 106 may include a fundraiser component 114. The fundraiser component 114 may include a number of sub-components or modules, such as an organizers component 116, a content component 118, a notification component 120, and/or a support component 122. The organizers component 116 may provide the organizer 102 with functionality to invite and/or add other organizers (e.g., the users 104) to contribute to the collaborative fundraiser. The content component 118 may be configured to provide functionality to create, edit, and post the content to the collaborative fundraiser event. The notification component 118 may be configured to send the content, alerts and/or notifications to other users of the social networking system (not shown) in response to the users 102 or 104 posting or otherwise editing the content associated with the collaborative fundraiser. In some cases, the notification component 118 may also be configured to determine a set or subset of users (not shown) to receive the collaborative content, alerts and/or notifications. The support component 122 may be configured to determine one or more of the organizers 102 and 104 to which to notify, alert, provide, and/or present support, comments, and the like related to the collaborative fundraiser.

With respect to FIG. 1, the organizer 102 may invite the users 104 to act as organizers or other type of contributors with respect to a collaborative fundraiser event. For instance, in the illustrated example, the organizer 102 may, at operation 124 (indicated by “1”), create a collaborative fundraiser event to, for example, raise funds or awareness for a beneficiary via the social networking system 106. For instance, the organizer 102 may generate or upload initial content associated with the fundraiser event, such as beneficiary information, cause information, desired donor actions, and the like to the social networking system 106. As part of the creation process, illustrated as operation 126 (indicated by “2”), the organizer 102 may select or otherwise indicate other users 104 to be invited to participate as organizers of and receive attribution for the collaborative fundraiser. For example, the organizer 102 may select the users 104 by typing or entering the user's account name, selecting the user 104 from a list or via other tagging events, and/or the like. In this example, operation 126 is separated from operation 124 but it should be understood that in some cases, the invitation process may be incorporated into the collaborative fundraiser event creation process.

In the illustrated example, at operation 128 (indicated by “3”), the social networking system 106 may generate an invitation or notification for each of the users (e.g., the users 104) selected by the organizer 102. Next, at operation 130 (indicated by “4”), each of the individual users 104 may receive the notification, via the notification component 120 of the social networking system 106. For example, the users 104 may receive a notification or alert as to the invitation to participate in the collaborative fundraiser event. In some cases, the notification or alert may include a selectable link, icon, or message that may allow each of the users 104 to agree or consent to participate with the organizer 102 with respect to the collaborative fundraiser event. In some cases, the notification may include information associated with the fundraiser event, such as beneficiary information, information associated with a cause or movement corresponding to the fundraiser, information associated with other organizers, information associated with current donors, and/or the like.

At operation 132 (indicated by “5”), the users 104 may accept the invitation to be added as an organizer with respect to the collaborative fundraiser event. For example, one or more of the users 104 may select the link, icon, or message to opt-in as an organizer or contributor with respect to the collaborative fundraiser event.

In this example, at operation 134 (indicated by “6”), the social networking system 106 may add the accepting users 104 as organizers. For example, the social networking system 106 may cause an indication of association of each organizer 102 and/or 104 to be presented in conjunction with content associated with the collaborative fundraising event when viewed or consumed by other users of the social networking system 106.

In the illustrated example, each of the computing devices 110 and 112 may include one or more processors and memory storing computer executable instructions to implement the functionality discussed herein attributable to the various computing devices. In some examples, the computing devices 110 and 112 may include desktop computers, laptop computers, tablet computers, mobile devices (e.g., smart phones or other cellular or mobile phones, mobile gaming devices, portable media devices, etc.), or other suitable computing devices. The computing devices 110 and 112 may execute one or more client applications, such as a web browser (e.g., Microsoft Windows Internet Explorer, Mozilla Firefox, Apple Safari, Google Chrome, Opera, etc.) or native or special-purpose client applications (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 110 and 112 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable its users 102 and 104 (such as persons or organizations) to interact with the social networking system 106 and with each other via the computing devices 110 and 112. The social networking system 106 may, with input from a user, create and store in the social networking system 106 a user account associated with the user. The user account may include demographic information, communication-channel information, and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the users.

In some examples, the social networking system 106 may provide privacy features to the users 102 and 104 while interacting with the social networking system 106. In particular examples, one or more objects (e.g., content or other types of objects) of the system 106 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a user, such as a user 102 and 104, may share an object to the social networking system 106. The object may be associated with a concept node connected to a user node of the user 102 and/or 104 by an edge. The user 102 and/or 104 may specify privacy settings that apply to a particular edge connecting to the concept node of the object or may specify privacy settings that apply to all edges connecting to the concept node. In some examples, the user 102 and/or 104 may share a set of objects of a particular object-type (e.g., a set of images). The user 102 and/or 104 may specify privacy settings with respect to all objects associated with the user 102 and/or 104 of that particular object-type as having a particular privacy setting (e.g., specifying that all images posted by the user 102 and/or 104 are visible only to friends of the user and/or users tagged in the images).

In particular examples, the social networking system 106 may present a “privacy wizard” (e.g., within a webpage, a module, one or more dialog boxes, or any other suitable interface) to the user 102 and/or 104 to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102 and/or 104 that may display, to the user 102 and/or 104, current privacy settings of the user 102 and/or 104. The dashboard functionality may be displayed to the user 102 and/or 104 at any appropriate time (e.g., following an input from the user 102 and/or 104 summoning the dashboard functionality, following the occurrence of a particular event or trigger action). The dashboard functionality may allow the user 102 and/or 104 to modify one or more of the user's current privacy settings at any time, in any suitable manner (e.g., redirecting the user 102 and/or 104 to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102 and/or 104 (or other entity) for a particular object stored in a data store, the social networking system 106 may send a request to the data store for the object. The request may identify the user 102 and/or 104 associated with the request and the object may be sent only to the user 102 and/or 104 (or a client system of the user) if the authorization server determines that the user 102 is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example, and not by way of limitation, one or more objects may be visible to a user's “Trending” page. In particular examples, an object may correspond to a particular user. The object may be content associated with the particular user or may be the particular user's account or information stored on the social networking system 106, or other computing systems. As an example, and not by way of limitation, the user 102 and/or 104 may view one or more other users 102 and/or 104 of an online social network through a “People You May Know” function of the online social network, or by viewing a list of friends of the user 102. As an example, and not by way of limitation, the user 102 and/or 104 may specify that they do not wish to see objects associated with a particular other user (e.g., the user 102 and/or 104) in their newsfeed or friends list. If the privacy settings for the object do not allow it to be surfaced to, discovered by, or visible to the user 102 and/or 104, the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example, and not by way of limitation, the user 102 and/or 104 may specify that the user's status updates are public, but any images shared by the user are visible only to the user's friends on the online social network. In some examples, the user 102 and/or 104 may specify different privacy settings for different types of entities, such as individual users, friends-of-friends, followers, user groups, or corporate entities. In some examples, the user 102 and/or 104 may specify a group of users that may view videos posted by the user 102 and/or 104, while keeping the videos from being visible to the user's employer. In particular examples, different privacy settings may be provided for different user groups or user demographics. As an example, and not by way of limitation, the user 102 and/or 104 may specify that other users who attend the same university as the user 102 and/or 104 may view the user's pictures, but that other users who are family members of the user 102 and/or 104 may not view those same pictures.

In particular examples, the social networking system 106 may provide one or more default privacy settings for each object of a particular object-type. A privacy setting for an object that is set to a default may be changed by a user associated with that object. As an example, and not by way of limitation, all images posted by the user 102 and/or 104 may have a default privacy setting of being visible only to friends of the first user and, for a particular image, the user 102 and/or 104 may change the privacy setting for the image to be visible to friends and friends-of-friends.

In particular examples, privacy settings may allow the user 102 and/or 104 to specify (e.g., by opting out, by not opting in) whether the social networking system 106 may receive, collect, log, or store particular objects or information associated with the user 102 and/or 104 for any purpose. In particular examples, privacy settings may allow the user 102 and/or 104 to specify whether particular applications or processes may access, store, or use particular objects or information associated with the user. The privacy settings may allow the user 102 and/or 104 to opt in or opt out of having objects or information accessed, stored, or used by specific applications or processes. The social networking system 106 may access such information in order to provide a particular function or service to the user 102 and/or 104, without the social networking system 106 having access to that information for any other purposes. Before accessing, storing, or using such objects or information, the social networking system 106 may prompt the user 102 and/or 104 to provide privacy settings specifying which applications or processes, if any, may access, store, or use the object or information prior to allowing any such action. As an example, and not by way of limitation, the user 102 and/or 104 may transmit a message to the user 102 and/or 104 via an application related to the online social network (e.g., a messaging app), and may specify privacy settings that such messages should not be stored by the social networking system 106.

In particular examples, the user 102 and/or 104 may specify whether particular types of objects or information associated with the user 102 and/or 104 may be accessed, stored, or used by the social networking system 106. As an example, and not by way of limitation, the user 102 and/or 104 may specify that images sent by the user 102 and/or 104 through the social networking system 106 may not be stored by the social networking system 106. In some examples, the user 102 and/or 104 may specify that messages sent from the user 102 and/or 104 to another user may not be stored by the social networking system 106. In some cases, the user 102 and/or 104 may specify that all objects sent via a particular application may be saved by the social networking system 106.

In particular examples, privacy settings may allow the user 102 and/or 104 to specify whether particular objects or information associated with the user 102 and/or 104 may be accessed from particular client systems or third-party systems. The privacy settings may allow the user 102 and/or 104 to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102 and/or 104 may be prompted to specify a particular privacy setting for each context. As an example, and not by way of limitation, the user 102 and/or 104 may utilize a location-services feature of the social networking system 106 to provide recommendations for restaurants or other places in proximity to the user 102 and/or 104. The default privacy settings of the user 102 and/or 104 may specify that the social networking system 106 may use location information provided from the computing device 110 and/or 112 of the user 102 and/or 104 to provide the location-based services, but that the social networking system 106 may not store the location information of the user 102 and/or 104 or provide it to any third-party systems. The user 102 and/or 104 may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, a user may specify that a particular image uploaded by the user is visible to the user's friends for the next week, after which time the image may no longer be accessible to other users. In some examples, a company may post content related to a product release ahead of the official launch and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example, and not by way of limitation, the user 102 may transmit a message to the user 104, and the social networking system 106 may temporarily store the message in a data store until the user 104 has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example, and not by way of limitation, the user 102 may share a first image and specify that the first image is to be public to all other users. At a later time, the user 102 and/or 104 may specify that any images shared by the user should be made visible only to a first user group. The social networking system 106 may determine that this privacy setting also applies to the first image and make the first image visible only to the first user group. In particular examples, the change in privacy settings may take effect only going forward. Continuing the example above, if the user 102 and/or 104 changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user's change to privacy may be a global change for all objects associated with the user.

In particular examples, the social networking system 106 may determine that user 102 and/or 104 may want to change one or more privacy settings in response to a trigger action associated with the user 102 and/or 104. The trigger action may be any suitable action on the online social network. As an example, and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102 and/or 104 to change the privacy settings regarding the visibility of objects associated with the user 102 and/or 104. The prompt may redirect the user 102 and/or 104 to a workflow process for editing privacy settings with respect to one or more entities associated with the trigger action. The privacy settings associated with the user 102 and/or 104 may be changed only in response to an explicit input from the user 102 and/or 104 and may not be changed without the approval of the user 102 and/or 104. As an example, and not by way of limitation, the workflow process may include providing the user 102 with the current privacy settings with respect to the user 104 or to a group of users (e.g., un-tagging the user 102 or the user 104 from particular objects, changing the visibility of particular objects with respect to the user 104 or a group of users), and receiving an indication from the user 102 to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example, and not by way of limitation, the social networking system 106 may send a reminder to the user to confirm his or her privacy settings every six months or after every ten photo posts. In particular examples, privacy settings may also allow users to control access to the objects or information on a per-request basis. As an example, and not by way of limitation, the social networking system 106 may notify the user whenever a third-party system attempts to access information associated with the user and require the user to provide verification that access should be allowed before proceeding.

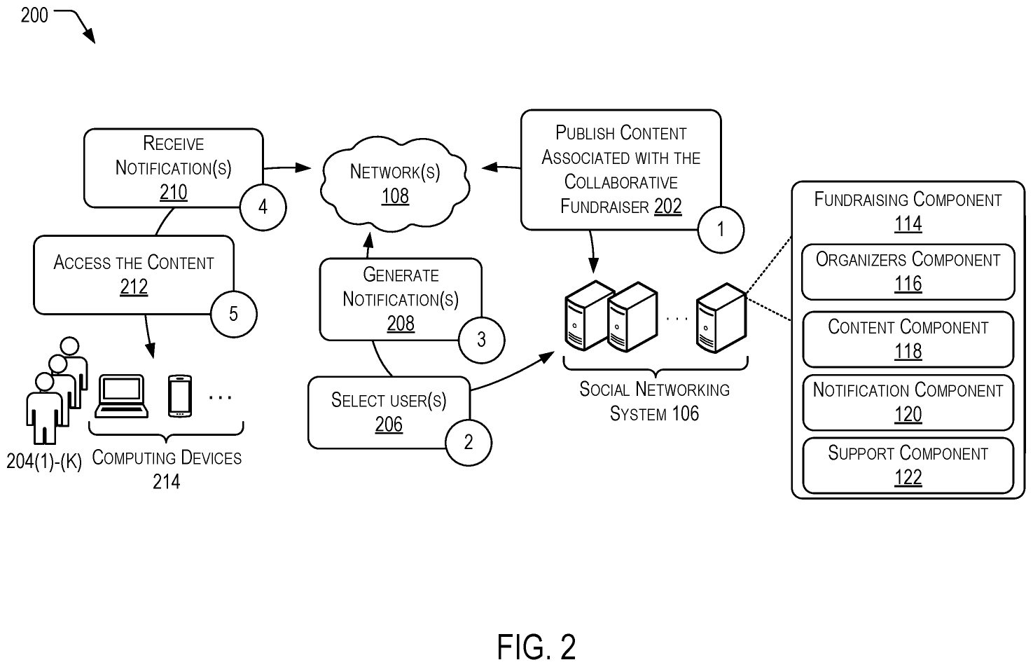

FIG. 2 illustrates another example system 200 to assist with hosting collaborative fundraiser events on a social networking system 106, according to some implementations. As discussed above, content associated with or uploaded to a collaborative fundraiser event may be associated with one or more of the users 102 and 104 of FIG. 1 and the social networking system 106 may select users, such as users 204(1)-(K) (collectively “users 204”) to receive a distribution of and/or notification related to the content responsive to the content is being uploaded or added to the collaborative fundraiser.

In the illustrated example, the social networking system 106 may, at operation 202 (indicated by “1”), publish the content associated with the collaborative fundraiser. As discussed above, the social networking system 106 may publish the content to a location associated with one or more of the user accounts of organizers and/or to a location associated with the collaborative fundraiser event. In one example, the content associated with the collaborative fundraiser event may be hosted by the user account of the original or primary organizer 102 but may be added or uploaded by any of the organizers 102 and/or 104. The content may also be displayed or presented with respect to a location (e.g., a home page, feed, or the like) associated with the organizer 104 and/or the fundraiser event in addition to a location associated with the organizer 102 regardless of where the content is hosted within the social networking system 106.

The social networking system 106 may, in addition to publishing to the one or more locations associated with the collaborative fundraiser event, also distribute or otherwise push the content and/or a notification related thereto to the additional users 204. For instance, the users 204 may interact with the social networking system 106 via a network 108 using computing devices, generally indicated by 214 to consume or otherwise view the content. In this example, the users 204 may be selected by the social networking system 106 to receive the distribution and/or notification of the content. Accordingly, in the illustrated example, the social networking system 106 may, at operation 206 (indicated by “2”), select the users 204 from the users of the social networking system 106 to receive the notification and/or distribution of the content. In some cases, the users 204 may be selected as a subset of the users that have followed or otherwise indicated an interest in content associated with one or more of the organizers 102 and 104 of the collaborative fundraiser event. In other cases, the users 204 may be selected based at least in part on a known interest of the user 204 in the beneficiary of the fundraiser event, content associated with the fundraiser event, topics associated with the fundraiser event, subjects associated with the fundraiser event, or other intersection of an areas of interest of the users 204 and the fundraiser event or historical consumption of the users 204, as well as other data known about the users 204, the fundraiser event, the organizers 102 and 104, and the like.

In some examples, the social networking system 106 may also filter the users 204 to remove any duplicate accounts in order to prevent any one user from receiving multiple notifications associated with the same content. For instance, if a first user has indicated an interest in content of two or more of the organizers, the social networking system 106 may remove or filter any duplicate instances of the first user's account from the set of users 204 prior to generating or sending the notification and/or distributing the content thereto.

At operation 208 (indicated by “3”), the social networking system may generate or otherwise send the notification to the selected users 204 and, at operation 210 (indicated by “4”), one or more of the users 204 may receive the notification. For example, the notification may be a message or insight including a summary or portion of the content and/or a selectable link to a posting of the content (such as a feed), and the like. In some cases, the content of the notification may be selected by one or more of the organizers, such as a selected featured image or portion of a video.

In this example, at operation 212 (indicated by “5”), the users 204 may access or otherwise consume the content associated with the collaborative fundraising event. For example, the users 204 may view, stream, or otherwise consume the content associated with the collaborative fundraiser event. In some cases, the content may include further links or access to other content related to the collaborative fundraiser event (such as links to donate or otherwise support the fundraiser event and/or the beneficiary).

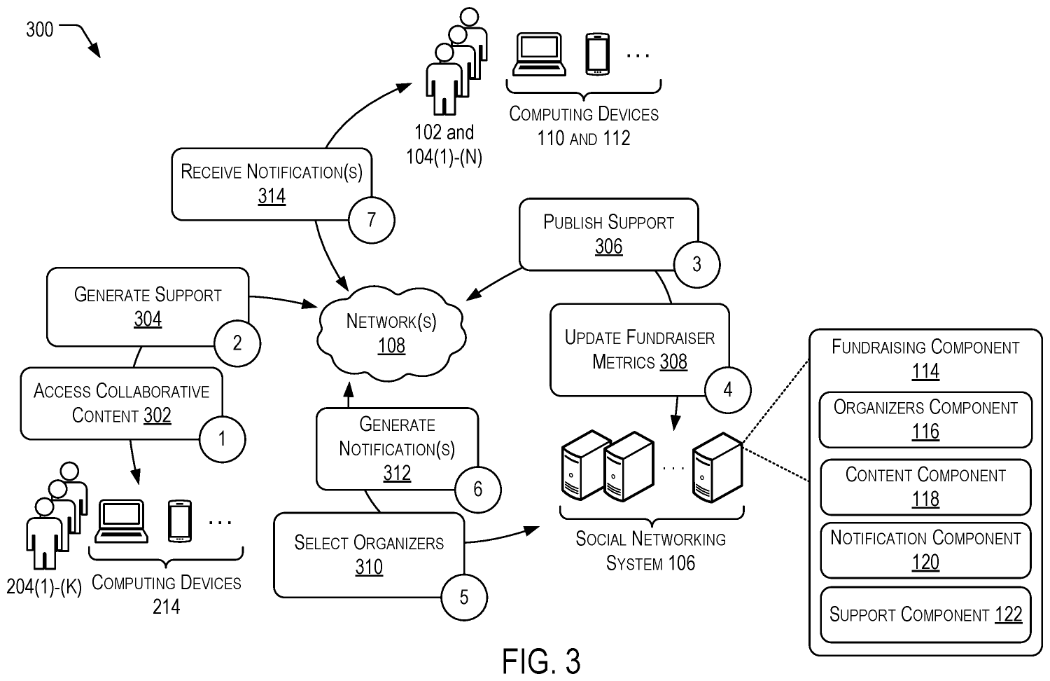

FIG. 3 illustrates yet another example system 300 for hosting collaborative fundraiser events on a social networking system 106, according to some implementations. In this example, the users 204 may have accessed or otherwise consumed the content associated with the collaborative fundraiser event and are providing comments or other support to the organizers 102 and 104 via the social networking system 106.

With respect to FIG. 3, at operation 302 (indicated by “1”), one or more of the users 204 may access the content associated with the collaborative fundraiser. For example, the social networking system 106 may stream or otherwise provide the content (such as video content) to the computing devices 214 associated with the users 204.

In this example, one or more of the users 204, at operation 304 (indicated by “2”), may generate support for the organizers 102 and 104. The support may take various forms, for instance, the support may include comments, likes, dislikes, shares, donations, or other support related to the content associated with the collaborative fundraiser. In some cases, the support may be directed to one or more of the individual organizers 102 and/or 104. For instance, the user 204 providing the support may select, mention, or otherwise indicate one or more of the organizers 102 and/or 104 when creating or generating the support via the social networking system 106.

In response to receiving the support, the social networking system 106, at operation 306 (indicated by “3”), may publish the support in association with the collaborative fundraiser event (e.g., the locations at which the fundraiser content is hosted, for example, in regard to the account of the primary organizer 102). In some cases, the support may be published as a comment or other addition to the content that is visible to a user, such as the users 204, consuming the content.

The social networking system 106 may also, at operation 308 (indicated by “4”), update collaborative fundraiser metrics associated with the collaborative fundraising event based at least in part on the support. For example, the social networking system 106 may modify one or more metric associated with the fundraiser event, such as increasing a number of likes, increasing a number of dislikes, increasing a number of comments, and the like. In some cases, the metrics may include a number of donors, an amount raised or donated, and the like. In some case, the metrics may be specific to particular content items while in other cases the metrics may be associated with the fundraiser as a whole. For instance, the content may include a number of likes for the individual content and the fundraiser event may include a number of likes for all content created with regards to the fundraiser event.

At operation 310 (indicated by “5”), the social networking system 106 may select one or more of the organizers (e.g., the users 102 and/or 104) to receive a notification related to the support and, at operation 312 (indicated by “6”), the social networking system 106 may generate and send the one or more notifications. For example, organizers 102 and/or 104 receiving the notifications may be selected based on content of the support, the type of support, a relationship between the user 204 generating the support and the user 102 and/or 104 receiving the support, and the like. In some cases, the organizers 102 and/or 104 may be scored and ranked with respect to the support, such that a top ranked organizers 102 and/or 104 may receive the notification related to the support.

The organizers 102 and/or 104 selected by the social networking system 106 may, at operation 314 (indicated by “7”), receive the notifications. In this manner, at least one of the organizers 102 and/or 104 may monitor support related to the content of the collaborative fundraiser event. In some cases, the individual organizer 102 and/or 104 monitoring and receiving the support may vary over individual content associated with the fundraiser event and/or over individual support to a specific content.

Additionally, it should be understood that by limiting the organizers 102 and/or 104 receiving the support, the social networking system 106 may reduce the number of responses by the organizers 102 and/or 104 with regards to the support. For example, in some cases, if each of the organizers 102 and/or 104 receive the support, each of the organizers 102 and/or 104 may respond resulting in duplicative responses potentially frustrating the user 204 generating the support and unnecessarily consuming network and system resources, as often a single response from the set of organizers 102 and/or 104 is sufficient. In some examples, the organizers 102 and/or 104 not selected by the social networking system 106 may receive a notification as to the selected organizers 102 and/or 104 responding, notifying them that they do not need to respond. In other examples, the social networking system 106 may, at least temporarily, restrict the unselected organizers 102 and/or 104 from responding to the support (e.g., for a predetermined period of time initiated from the time the support was uploaded to the system 106).

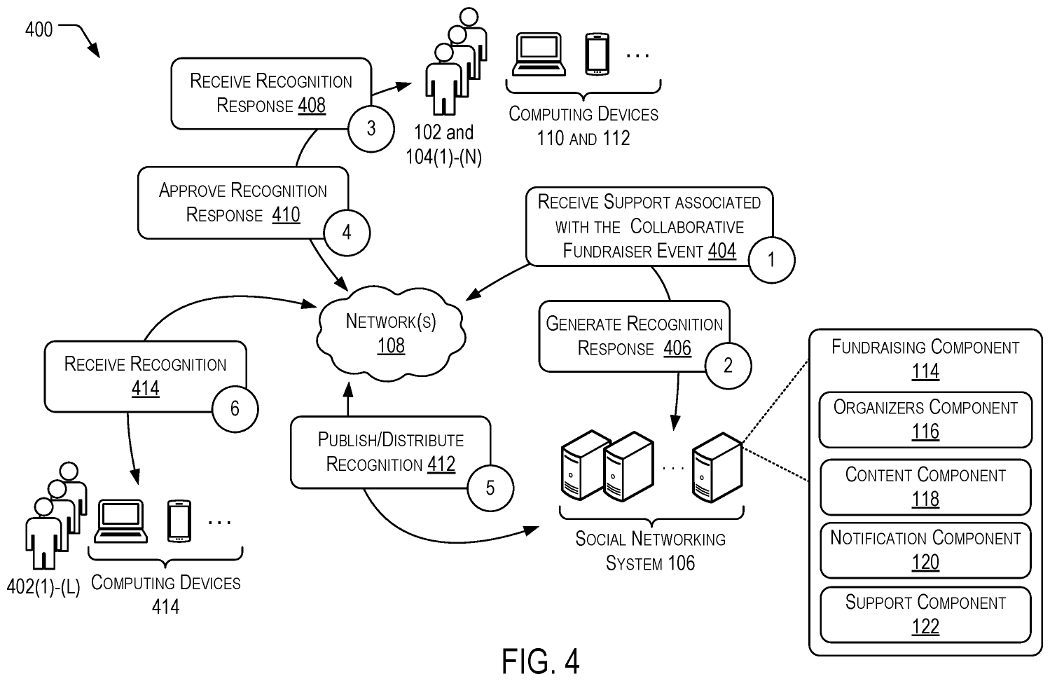

FIG. 4 is a view of yet another example system 400 to assist with hosting collaborative fundraiser events on a social networking system 106, according to some implementations. In this example, the social networking system 106 may be configured to assist the organizers 102 and/or 104 in providing public and/or private recognition for the donations and other support (e.g., likes, shares, re-posts, and the like) associated with the collaborative fundraiser events. For instance, providing recognition to supporters' contributions to the fundraiser and/or cause is often an important part of encouraging future donations by either the recognized support and/or other additional supporters. However, in large social networking based fundraising events, particularly with large number of donors or supports that contribute small amounts, providing sufficient and meaningful recognition may become a burden on the organizers 102 and/or 104. Further, the types of expected recognition expected by the supports may vary depending on the level of relationship between the organizers 102 and/or 104 and the supports as well as on the relationship between the beneficiary's and the supports.

In the illustrated example, one or more supporters 402(1)-(L) (collectively “supporters 402”) may be receiving recognition from one or more of the organizers 102 and/or 104, for instance via the social networking system 106 and the computing devices 414, in response to a donation and/or other show of support for the collaborative fundraiser event.

At operation 404 (indicated by “1”), the social networking system 106 may receive support from a supporter 402 associated with the collaborative fundraiser event. For example, the supporter 402 may donate, share, like, re-post content associated with, or otherwise provide support for the collaborative fundraiser.

In this example, the social networking system 106 may then, at operation 406 (indicated by “2”), generate a recognition response associated with the support of the supporters 402. For example, the social networking system 106 may assist the organizers 102 and/or 104 by selecting, filtering, or otherwise grouping the supports 402 in a manner that increases the ease with which the supporters 402 may be recognized by the organizers 102 and/or 104. In some cases, the social networking system 106 may group or sort the supports 402 into sets of a predetermined number (e.g., 15, 10, 5, etc.) that may be recognized as a group or via the same type or recognition response. The supports 402 may be grouped or filtered based on relationships to the organizers 102 and/or 104, a type of support (e.g., donations verses likes or shares), an amount of support (e.g., the amount of the donations), a status with the social networking system 106 (such as a verification, follower size, frequency or amount of posts/content, and the like), a physical location, social or economic status, known demographic information, and the like. In some instances, the supports 402 may be selected at random to, for instance, increase a diversification or distribution of the recognition.

In the illustrative example, one or more of the organizers 102 and/or 104 may receive the recognition response, at operation 408 (indicated by “3”), and approve the recognition response, at operation 410 (indicated by “4”). For example, the organizers 102 and/or 104 may edit, update, or otherwise modify the recognition response prior to distribution. For instance, the organizers 102 and/or 104 may add a personal touch or comment to the recognition, remove/add other supports 404 to the recognition response, and the like.

At operation 410 (indicated by “5”), the social networking system 106 may publish or distribute the recognition 412 and, at operation 414 (indicated by “6”), the selected supporters 402 may receive the recognition. For example, the recognition may be public and available to all users of the social networking system 106 or a private message between an organizer 102 or 104 and the selected supporter 402. For instance, the public recognition may be used to encourage additional users to become supporters, while the private recognition may add more of a personal touch and be more meaningful to the individual supporter.

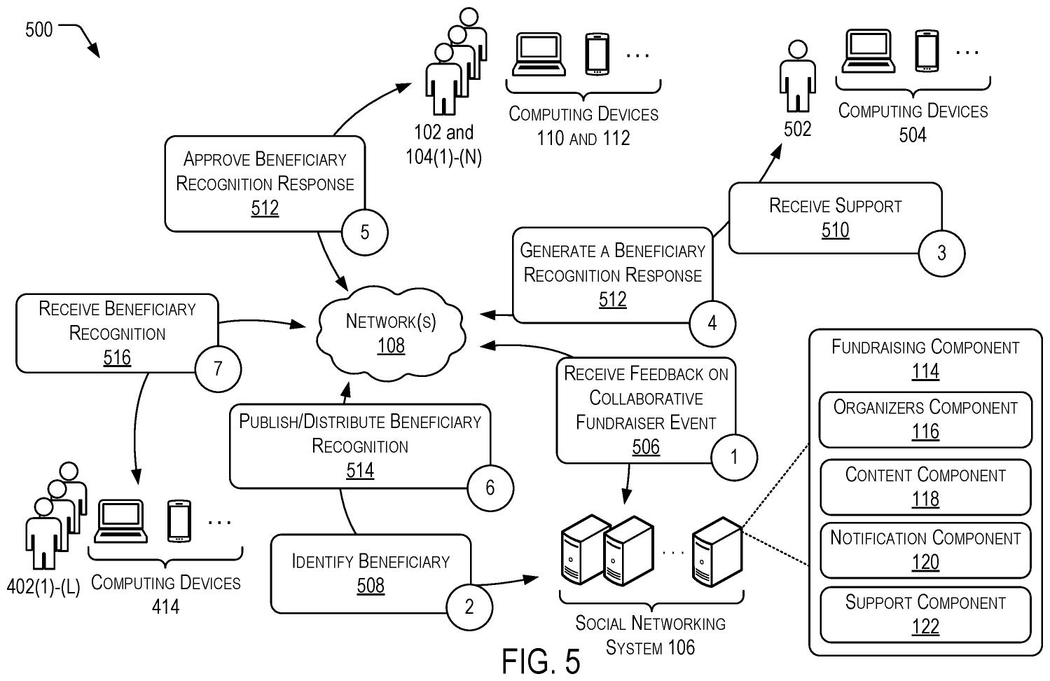

FIG. 5 illustrates yet another example system 500 for hosting collaborative fundraiser events on a social networking system 106, according to some implementations. In this example, the social networking system 106 may be configured to assist the beneficiary 502 of the fundraising event in providing public and/or private recognition for the donations and other support (e.g., likes, shares, re-posts, and the like) of the users of the social networking system 106. As discussed above, providing recognition for contributions to the fundraiser event and/or a cause associated therewith is often an important part of encouraging future donations by either the recognized supporters and/or other additional supporters. However, in large social networking-based fundraising events, often only the organizers 102 and/or 104 are capable of providing recognition as the beneficiary 502 does not have access to the fundraiser event page and/or account. Accordingly, the social networking system 106, discussed herein, may allow the beneficiary 502 to act as an additional class of authorized user with respect to the fundraising event. For instance, the beneficiary 502 may be able to review metrics, receive notifications associated with support or support by the supporters 402, and/or provide recognition or other type of gratitude for the donations of the supporters 402.

In the illustrated example, the beneficiary 502 may provide recognition to one or more of the supporters 402 via, for instance, computing devices 504. Accordingly, at operation 506 (indicated by “1”), the social networking system 106 may receive support from a supporter 402 associated with the collaborative fundraiser event. For example, the supporter 402 may donate, share, like, re-post content associated with, or otherwise provide support for the collaborative fundraiser.

In this example, the social networking system 106 may then, at operation 508 (indicated by “2”), identify the beneficiary 502. For example, the social networking system 106 may identify the beneficiary 502 of the fundraiser event associated with the support, the donation (e.g., a click through or the like), and/or other type of support. In some examples, the social networking system 106 may also determine the amount and/or type of support meets or exceeds one or more criteria associated with notifying the beneficiary 502 or earning the recognition of the beneficiary 502. For example, the criteria may include a donation amount, a status with the social networking system 106 (in some cases, the status may be determined based at least in part on a number of followers, an amount of content, a metric associated with interactions, and the like), a number of views associated with the support, a number of shares associated with the support, a reach associated with the supporter, and the like.

In some examples, the social networking system 106 may also, in addition to identifying the beneficiary 502, generate a prepopulated beneficiary recognition response associated with the support of the supporters 402. For example, the social networking system 106 may assist the beneficiary 502 by selecting, filtering, or otherwise grouping the supporters 402 in a manner that increases the ease with which the supporters 402 may be recognized by the beneficiary 502 and/or by generating content for the beneficiary recognition (e.g., text, images, videos, and the like).

In this example, the beneficiary 502 may receive the recognition response at operation 510 (indicated by “3”) and, at operation 512 (indicated by “4”), generate a beneficiary recognition response. For example, the beneficiary 502 may upload or otherwise create content to utilize as a recognition response and/or approve the prepopulated beneficiary recognition response provided by the social networking system 106.

In this example, one or more of the organizers 102 and/or 104 may, at operation 512 (indicated by “5”), receive and approve the beneficiary recognition response. In some cases, the beneficiary 502 may be preauthorized to post content to the social networking system 106 associated with the fundraising event. In these cases, the social networking system 106 may not require one or more of the organizers 102 and/or 104 to approve the beneficiary recognition prior to publishing. In other examples, the organizers 102 and/or 104 may only approve public beneficiary recognition and the beneficiary 502 may send private recognition without organizer approval.

At operation 514 (indicated by “6”), the social networking system 106 may publish or distribute the beneficiary recognition and, at operation 516 (indicated by “7”), the supporters 402 may receive the recognition. For example, the recognition may be public and available to all users of the social networking system 106 or a private message between the beneficiary 102 or 104 and the selected supporter 402. For instance, the public recognition may be used to encourage additional users to become supporters, while the private recognition may add more of a personal touch and may be more meaningful to the individual supporter.

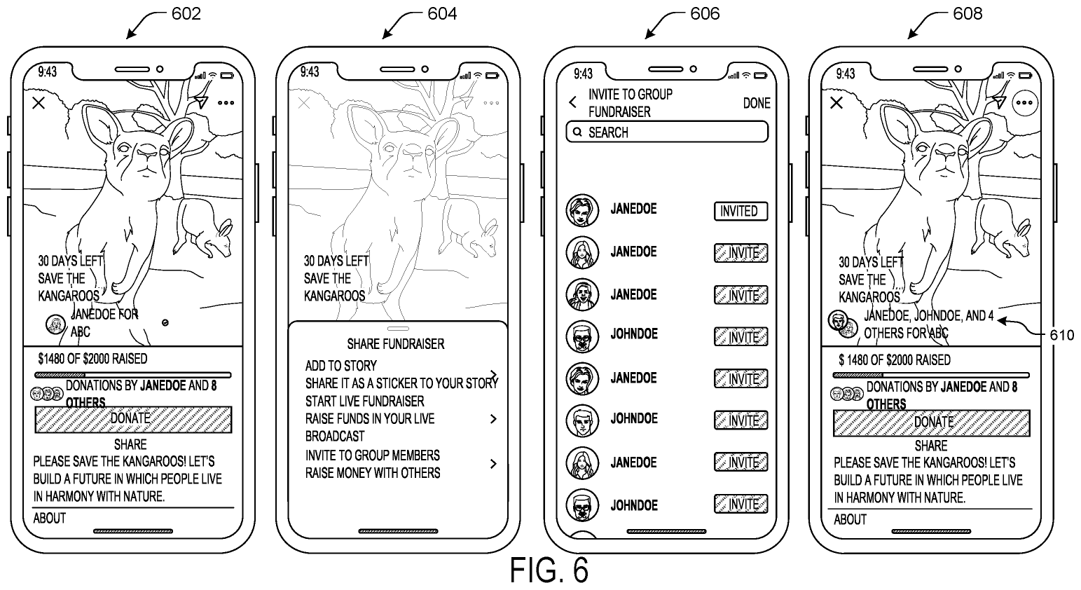

FIG. 6 illustrates example interfaces associated with creating a collaborative fundraiser event according to some implementations. In an example, a primary organizer may generate, arrange, and/or upload content associated with a fundraiser event. In the illustrative example, the fundraiser event may be associated with saving the kangaroos. The organizer may create the fundraiser event in a private mode, and then select the share icon, as shown in interface 602, to cause the social networking system to publish the fundraiser event when ready.

Once the share icon is selected, the social networking system may present the interface 604. Using the interface 604, the organizer may further update the fundraiser event, start or publish the fundraiser event, and/or invite other users to act as organizer of the fundraiser event. In this example, when the organizer selects the invite other users icon, the display transitions to interface 606. Using interface 606, the organizer may select one or more related users of the social networking system to join as an organizer. For example, in the illustrate example, the organizer has invited “janedoe” to join as an organizer. In some cases, the social networking system may rank or otherwise select the users to be presented via the interface 606 based on various criteria (e.g. one or more), such as relationship status to the organizer, frequency of interactions between the user and the organizer, historical collaborations, shared interests, a status with the social networking system, or the like. In some cases, the user may also type the account name to cause the social networking system to display the desired user in conjunction with the invite list.

Once the invited users accept, the invited user may be listed as an organizer with respect to content of the collaborative fundraiser. For example, as illustrated with respect to interface 608, the user “janedoe” has been included together with the primary organizer in an attribution area 610 of the interface 608.

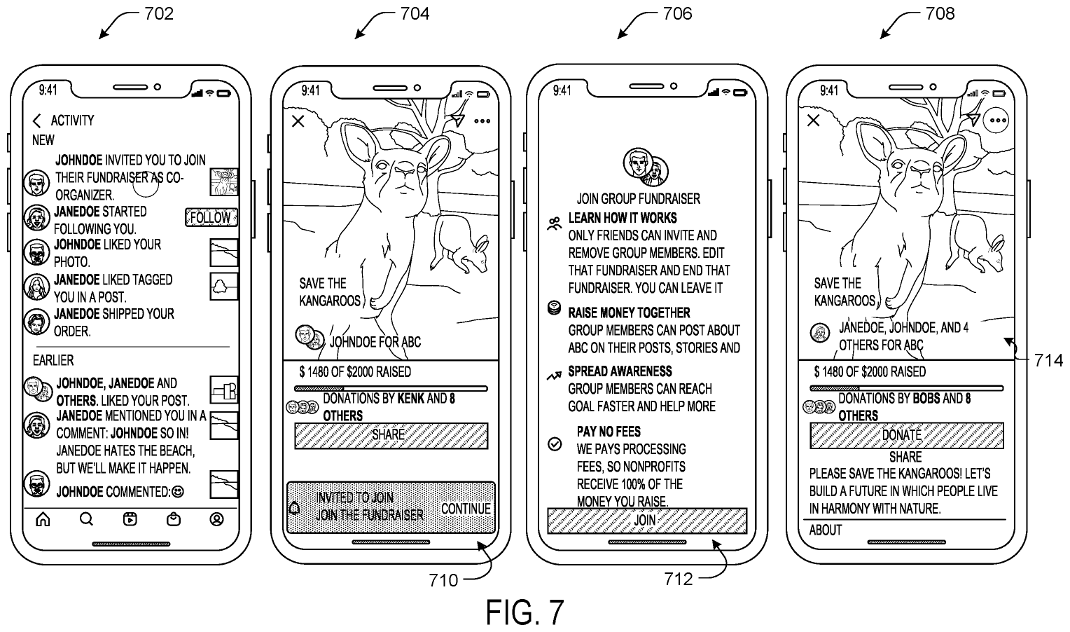

FIG. 7 illustrate example interfaces associated with accepting an invitation to join a collaborative fundraiser event as an organizer according to some implementations. In the illustrated interface 702, the invited user (e.g., “janedoe”) has received an invitation to join as an organizer of a collaborative fundraising event to save the kangaroos from the original organizer (e.g., “johndoe”). The invited user may then select the notification to transition to interface 704. Using interface 704, the invited user may be presented with the fundraiser event content and include an option to confirm the invitation, generally indicated by 710. In this manner, the invited user may view the content associated with the collaborative fundraiser event prior to agreeing to contribute as an organizer.

If the invited user confirms or accepts the invitation, the social network system may transition the invited user's display to interface 706. Using interface 706, the invited user may receive information associated with collaborative fundraiser events via the social networking system or other information associated with terms and conditions that may apply when the invited user joins as an organizer. The invited user may then select the join icon 712 to finalize their assent to participate as an organizer. Once the invited user finalizes their participation, the invited user may be displayed as an organizer with respect to content of the collaborative fundraiser. For example, as illustrated with respect to interface 708, the user “janedoe” has been included together with the primary organizer “johndoe” in an attribution area 714.

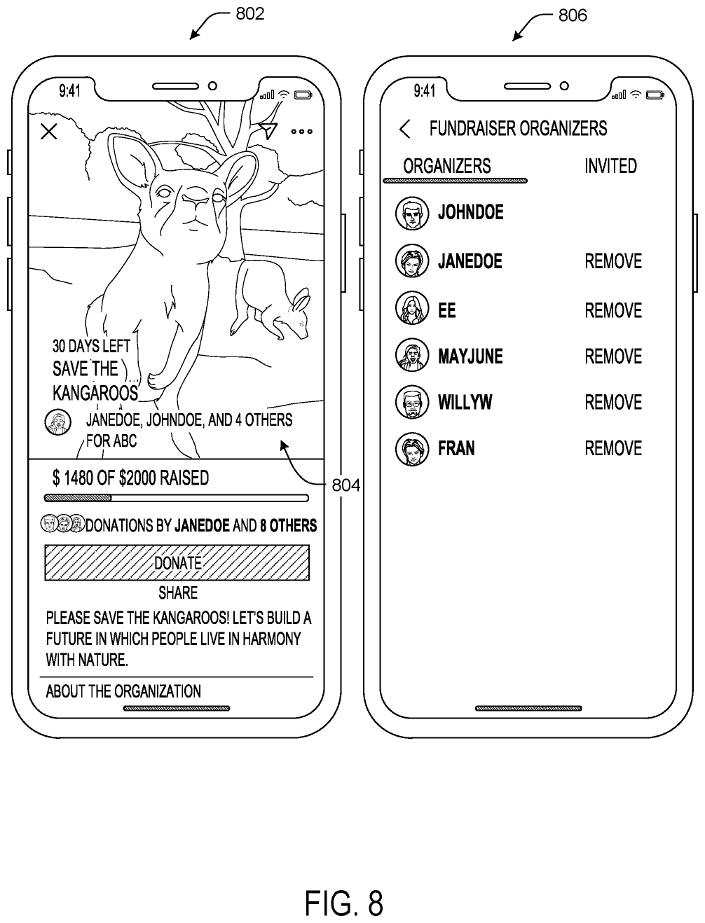

FIG. 8 illustrates example interfaces associated with the collaborative fundraiser event according to some implementations. In this example, a user consuming content associated with the fundraiser event may view data associated with the organizers. For instance, the interface 802 may list a predetermined number of organizers in an attribution area 804.

However, in some cases, more than the predetermined number of organizers may be involved or associated with the collaborative fundraiser event. In this example, the social networking system may rank the organizers and display the top ranking predetermined number of organizers in the attribution area 804. In some cases, the ranking may be based on an invitation order (e.g., order in which the users were selected by the primary organizer to receive an invitation), invitation acceptance order, contribution order (e.g., amount of content created, support provided, etc.), status with the social networking system (e.g., influencer, etc.), amount of donations attributable to content of individual organizers, and the like. In some cases, a consuming user may select the attribution area 804 to view the full list of organizers, as shown in interface 806.

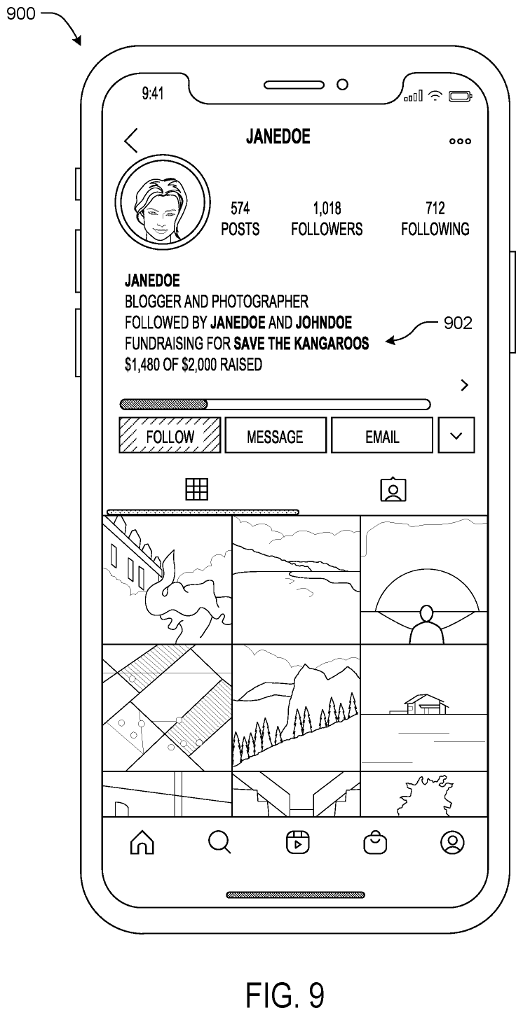

FIG. 9 is an illustration of an example interface 900 associated with an organizer that is participating in a collaborative fundraiser event according to some implementations. In this example, a home page associated with an account of an organizer (e.g., “janedoe”) is shown. In this example, as the user is participating as an organizer in an active collaborative fundraising event, the event information (e.g., name, goals, and current contribution, or the like) may be displayed in a fundraising area 902 of the home page. In some cases, a consuming user may transition to the collaborative fundraiser event by selecting or interacting with the fundraising area 902.

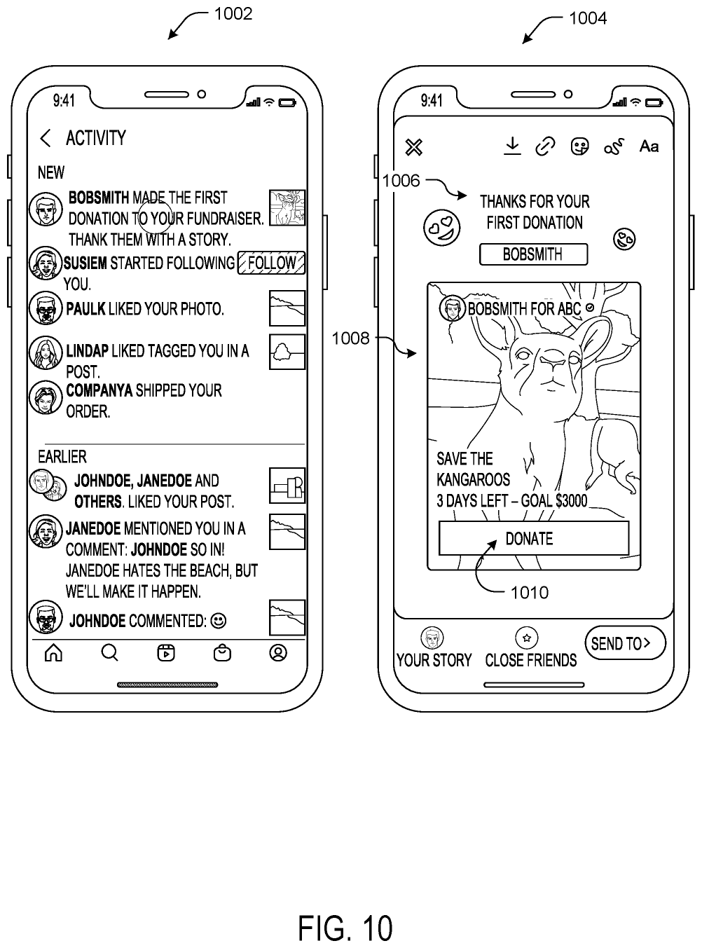

FIG. 10 illustrates example interfaces associated with organizer notification and recognition associated with a collaborative fundraising event receiving contributions or support via the social networking system according to some implementations. As discussed above, in response to a user providing support for the collaborative fundraising event, such as content, support, shares, likes, donations, etc., one or more of the organizers may receive a notification or alert associated with the support. In some cases, the notification may be displayed in a feed, such as that illustrated in interface 1002. As discussed above, the organizer receiving the notification may be selected from the set of organizers to reduce the overall duplicity, network and system resources being consumed with generating the notification and publishing recognition in response. The organizer may be selected based on a relationship to between the organizer and the supporter, a status of the organizer and/or support with respect to the social networking system, and the like.

If the organizer selects the notification, the display may transition to interface 1004. The interface 1004 may include a recognition that may be populated or generated by the social networking system and/or generated or customized by the organizer using one or more recognition tools provided by the social networking system. In this example, the recognition includes a text portion 1006, an image or video portion 1008, and a call to action 1010 for other users of the social networking system.

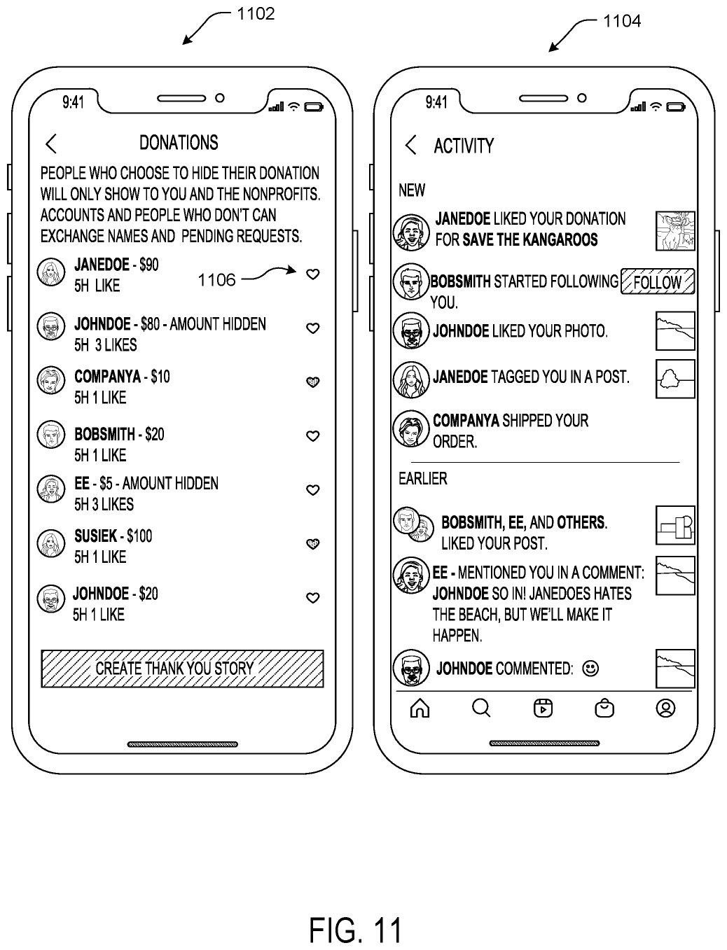

FIG. 11 illustrates example interfaces associated with providing recognition for contributions to or support of a collaborative fundraising event according to some implementations. In the illustrative example, an organizer (or, in some examples, other users of the social networking system) may be presented with the interface 1102 to review, view, or otherwise consume the list of support provided by the supporters of the collaborative fundraising event. Using interface 1102, the organizer or other user may view the donation amounts, the amount of positive support (e.g., likes) associated with a donation, and/or the like. The interface 1102 may also allow the organizer or other user to generate recognition for the donation or other support. For instance, as illustrated the interface 1102 includes selectable icons, generally indicated by 1106, that may be used to provide a like or other lightweight recognition for the donation. In other examples, the interface 1102 may also include messaging icons, automated recognition icons, and the like.

Once a user recognizes a supporter, the supporter may receive a notification associated therewith, such as illustrated with respect to interface 1104. For example, the organizer “janedoe” has recognized the support for donating to the collaborative fundraiser event and a notification of the recognition is presented to the support via interface 1104.

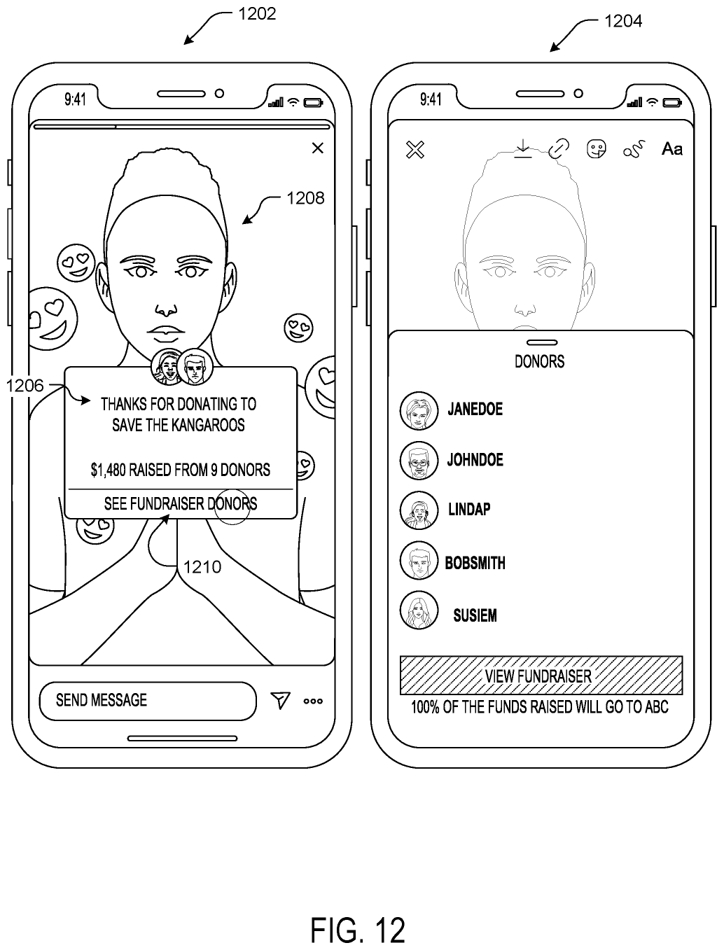

FIG. 12 illustrates example interfaces associated with a recognition response associated with a collaborative fundraising event according to some implementations. In the current example, a user may view a recognition response, via interface 1202, from an organizer. The recognition response may include a text portion 1206, an image or video portion 1208, and a option to view associated organizers 1210, as shown. If a user selects the portion 1210, the display may transition to interface 1204 and the social networking system may display a list of donors associated with the fundraising event, an amount per donor, a total amount raised, and the like.

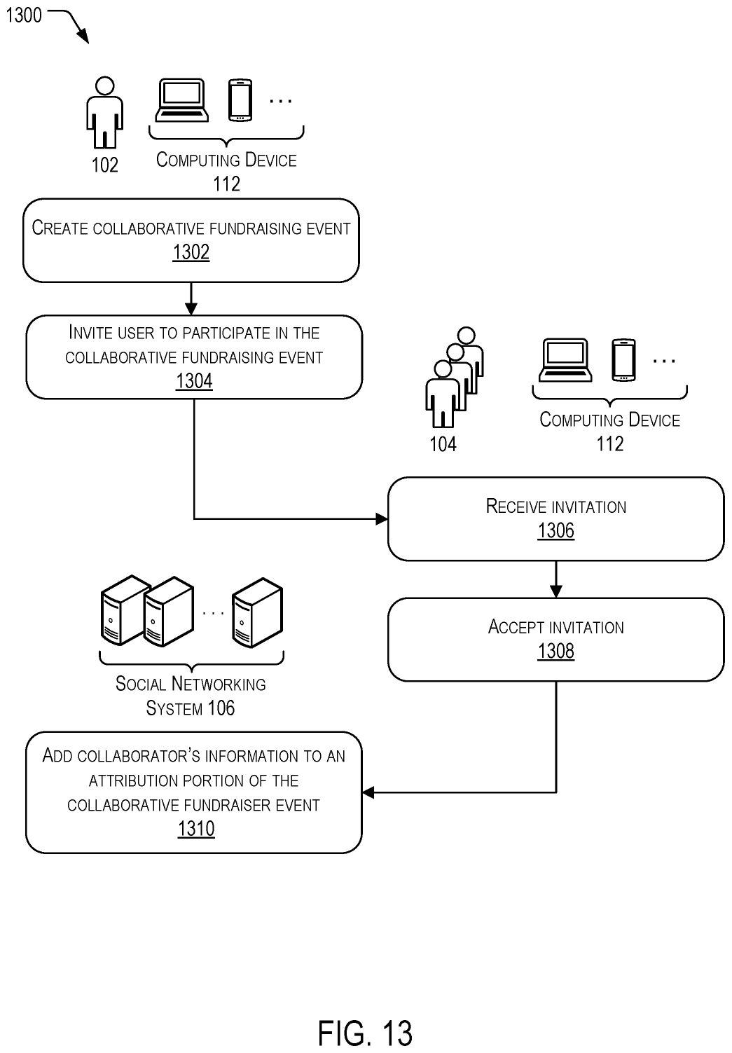

FIGS. 13-15 are flow diagrams illustrating example processes associated with the collaborative fundraising events as discussed above. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 13 is a flow diagram illustrating an example process 1300 for inviting organizers, such as user 104, to participate in a collaborative fundraising event according to some implementations. In the illustrated example, an original or primary organizer 102 may create a collaborative fundraising event via the social networking system 106. As part of the creation process 1300, the organizer 102 may invite other users, such as the users 104 of the social networking system 106 to participate as organizers in the collaborative fundraising event.

At 1302, the primary organizer 102 may create the collaborative fundraiser event. For example, the primary organizer 102 may structure the collaborative fundraiser and/or otherwise add the content to the collaborative fundraiser event via one or more tools associated with the social networking system 106. For example, the primary organizer 102 may set fundraising goals, identify a beneficiary and/or cause associated with the collaborative fundraiser event, and the like.

At 1304, the organizer 102 may invite or otherwise select other users (e.g., users 104), to participate in the collaborative fundraising event as organizers and, at 1306, the users 104 may receive the invitations. For example, the organizer 102 may select the users 104 by typing or entering the users' names, selecting the users 104 from a list or other tagged content, and the like. In this implementation, it should be understood that the invitation may be incorporated into the collaborative fundraising event creation process or be performed as a separate process at a later time.

At 1308, the users 104 may accept the invitations. For example, the invitations may be in the form of a notification or alert as including a selectable option to accept. If the users 104 accepts, the process 1300 proceeds to 1310, otherwise the invitation may either remain open, be closed by the organizer 102, be closed by the user 104, expire after a period of time elapses, or the like. It should be understood that if one or more of the users 104 do not accept the invitation, the user 104 will not be added or otherwise associated with the fundraiser event. In some cases, the social networking system 106 may also send reminders or alerts to the users 104 that have neither accepted nor closed the invitation, such as to show the user 104 that the fundraiser is progressing or receiving traction towards the stated goal and the like.

At 1310, the social networking system 106 may add the organizer's information (e.g., the information of the accepting users 104) to the collaborative fundraising event, as discussed above, in response to receiving the corresponding acceptance. That is, the social networking system 106 may associate the accepting users 104 with the collaborative fundraising event. Once added, the accepting users 104 may be listed as participating in, contributing to, and/or the like with respect to content associated with the collaborative fundraising event, as discussed above.

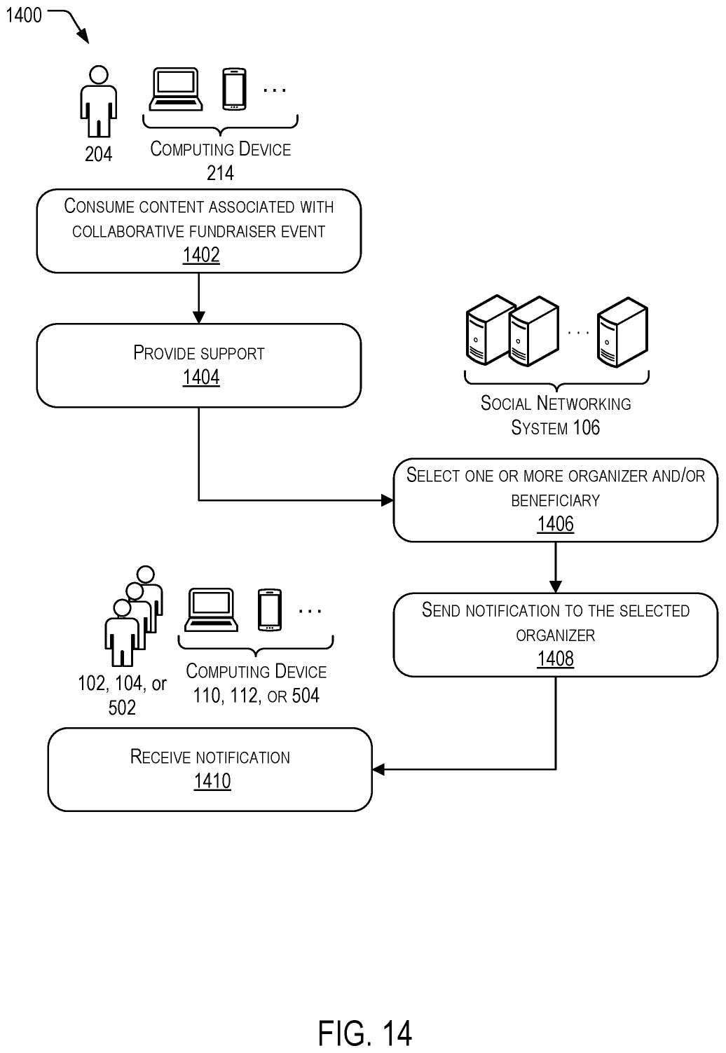

FIG. 14 is a flow diagram illustrating an example process 1400 for notifying organizers 102 or 104 in regard to donations and other support associated with a collaborative fundraising event according to some implementations. For example, in many cases, the organizers 102 or 104 may desire to recognize supports of the collaborative fundraising event. In some cases, to reduce the overall duplication of recognition, the social networking system 106 may select or otherwise limit the number of organizers that are notified regarding specific instances of user support for the fundraiser event. Additionally or alternatively, the social networking system 106 may provide an indication that recognition has previously been provided to select supporters of the collaborative fundraising event, thereby preventing duplicative recognitions.

At 1402, a user 204 may consume the content associated with a fundraiser event. For example, the user 204 may consume the content by viewing or streaming the content from the social networking system 106 via the computing devices 214. In some cases, as the user 204 streams or views the content, the social networking system 106 may cause information (e.g., attribution) associated with the organizers 102 and/or 104 to be displayed adjacent to or in conjunction with the content on the display of the computing device 214.

At 1404, the user 204 may provide support for the collaborative fundraiser event. For instance, the user 204 may donate, share, like, or otherwise provide support for the collaborative fundraiser event.

At 1406, the social networking system 106 may select one or more organizers and/or beneficiaries associated with the collaborative fundraiser event to receive a notification associated with the support. For example, the social networking system 106 may select the organizer and/or beneficiary based at least in part on a relationship of the organizer/beneficiary to the user 204, a type of support, an amount of support, a status with the social networking system 106 of the user 204 and/or the organizer/beneficiary, and the like.

In some cases, the social networking system 106 may select the organizer/beneficiary to notify to reduce the amount of recognition that is received by the user 204. For example, a feed or alert system associated with the user 204 may be overwhelmed if the fundraiser event has a large number of organizers (e.g., 50+, 100+, 1000+, or the like) and, for instance, the user 204 makes a large donation, such that each of or a majority of the organizers/beneficiary attempt to provide recognition. For instance, the user 204 may not appreciate receiving 100 or more individual recognition replies to a donation as the recognition may interfere with normal operations between the user 204 and the social networking system 106, and thus, may unintentionally deter future donations by the user 204.

At 1408, the social networking system 106 may send a notification to the selected organizers 102 or 104 and/or beneficiaries 502 and, at 1410, the organizers 102 or 104 and/or beneficiaries 502 may receive the notification. The organizers 102 or 104 and/or beneficiaries 502 may then respond in various manners to the support, for instance, as discussed herein. In some cases, the social networking system 106 may also restrict the unselected organizers 102 and/or 104 from responding to the support in some instances, such as for a predetermined period of time.

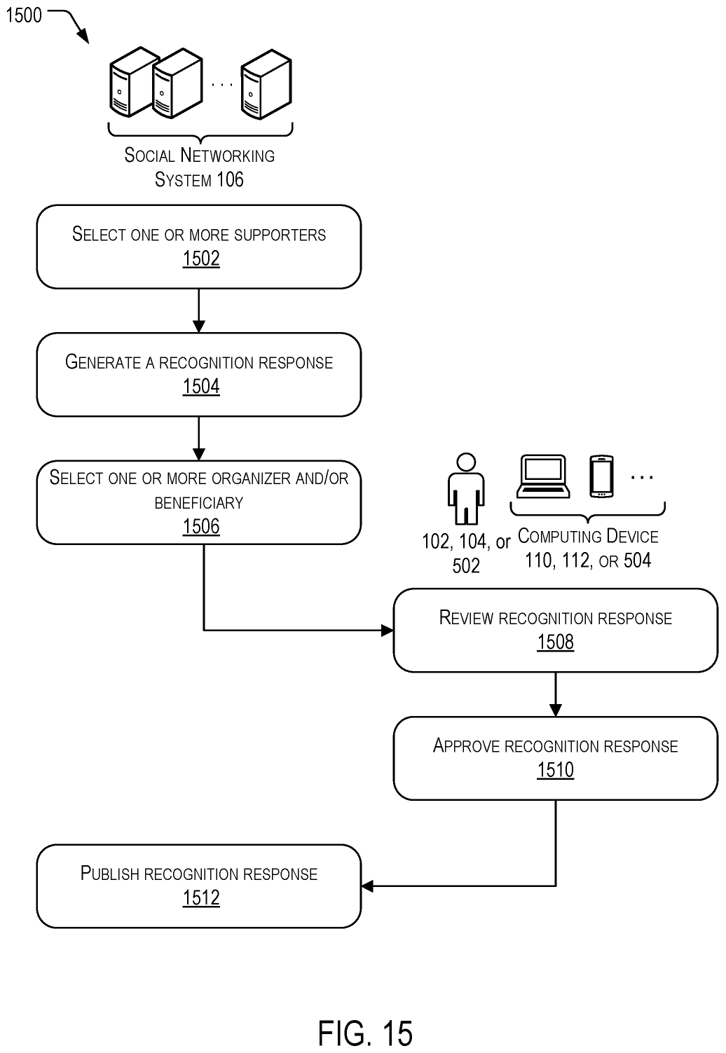

FIG. 15 is a flow diagram illustrating an example process 1500 for assisting organizers 102 or 104 as well as beneficiaries 502 in providing recognition for support of a collaborative fundraising event according to some implementations. In some examples, the organizers 102 and/or 104 as well as the beneficiaries 502 may have difficulty in recognizing contributions, donations, and other support for a fundraising event. This may be a particular issue when there are a large number of supporters and only a few organizers 102 and/or 104. In some cases, the social networking system 106 may be configured to assist the organizers 102 or 104 and/or the beneficiaries 502 in generating and providing recognition to the supporters.

At 1502, the social networking system 106 may select one or more supporters. For example, the social networking system 106 may select the supporters based on various criteria, such as an amount of a donation (e.g., greater than an amount threshold, greater than a ratio threshold with respect to other supporters' donations, a donation ranking compared to other donors, or the like), a status with the social networking system 106 (e.g., greater than a follower threshold, greater than a content per time period threshold, and the like), a relationship to one or more of the organizers 102 or 104 and/or a relationship with the beneficiary 502, and the like. In some cases, the social networking system 106 may select a single supporter while in other cases, the social networking system 106 may select a predetermined number of supporters as a batch, such as 10 or less, 5 or less, or the like.

At 1504, the social networking system 106 may generate a recognition response. For example, as discussed above, the social networking system 106 may generate or populate a text portion and select and/or populate a video or image portion of a recognition template. In some cases, the text and/or the image content may be selected based on the type of support, an amount of support, a status of the supporter with the social networking system 106, a relationship between the supporter and one or more of the organizers 102 or 104, a relationship between the supporter and one or more of the beneficiaries 502, and the like.

In some examples, at 1506, the social networking system 106 may select one or more organizer and/or beneficiary associated with the collaborative fundraiser event to approve the recognition response. For example, as discussed above, the social networking system 106 may select the organizer and/or beneficiary based at least in part on a relationship of the organizer/beneficiary to the user 204, a type of support, an amount of support, a status with the social networking system 106 of the user 204 and/or the organizer/beneficiary, and the like.

At 1508, the organizer 102 or 104 and/or the beneficiary 502 may receive and review the recognition response and, at 1510, approve the recognition response. For example, the organizer 102 or 104 may add a personal touch, such as an image, video, or textual content, or the like based on information the organizer 102 or 104 knows about one or more of the supporters during the review. In other cases, the organizer 102 or 104 may add or remove one or more of the supporters receiving the recognition response or the like. Once the organizer 102 or 104 is ready, the organizer 102 or 104 may approve the recognition response. Then, at 1512, the social networking system 106 may publish the recognition response.

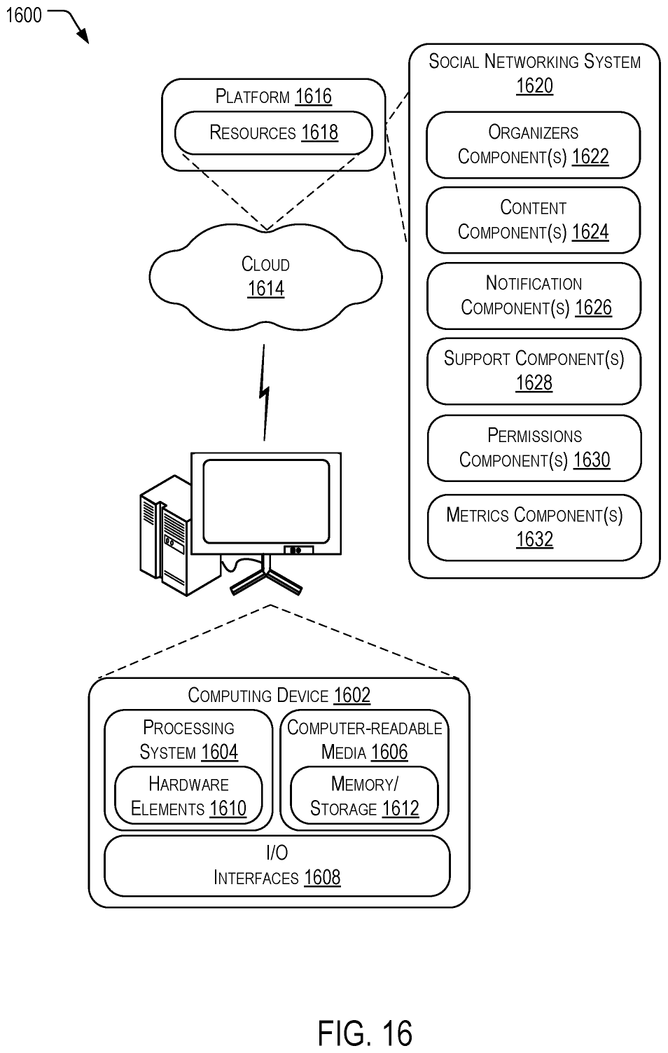

FIG. 16 illustrates an example system generally at 1600 that includes an example computing device 1602 that is representative of one or more computing systems and/or devices that may implement the various techniques described herein. This is illustrated through inclusion of a social networking system 1620 comprising a organizers component 1622, a content component 1624, a notification component 1626, a support component 1628, a permission component 1630, and a metrics component 1632.

The organizers component 1622, such as organizers component 116, may be configured to assist an original organizer (or other organizer) with respect to inviting additional users of the social networking system to participate in the collaborative fundraising event. In some cases, the organizers component 1622 may also assist one or more of the organizers in withdrawing from the collaborative fundraiser event.

The content component 1624, such as content component 118, may be configured to assist with publishing instances of the fundraiser content, generating fundraiser content, and/or attributing credit for the fundraiser content between the organizers.

The notification component 1626, such as notification component 120, may be configured to provide notifications related to newly added fundraiser content and/or support to the users of the social networking system 1620. In some cases, the notification component 1626 may assist with filtering users receiving the notification as users accept invitations to participate, and support for the fundraiser event is received.

The support component 1628, such as support component 122, may be configured to assist with identifying one or more organizers and/or beneficiaries to receive the support for the collaborative fundraising event. For example, the support component 1628 may select one or more of the organizers to receive and respond to the support and to generate or otherwise populate recognition responses on behalf of the organizers or beneficiaries.

The permission component 1630 may be configured to allow an original organizer, such as an organizer 102 of FIG. 1, or other designated organizer to control permissions with respect to the collaborative fundraiser event. In some cases, the permissions may include editing the fundraiser content, deleting the fundraiser content, pinning comments associated with the fundraiser content, disabling and/or enabling commenting with regards to the fundraiser content, applying or selecting filters for comments of the fundraiser content, viewing insights or metrics associated with the fundraiser content, promoting the fundraiser content, inviting organizers, archiving the fundraiser content, and the like.

The metrics component 1632 may be configured to allow various users of the social networking system 1620 to access and review metrics associated with the collaborative fundraiser event. For example, the metrics component 1632 may allow organizers, beneficiaries, and in some cases, other users of the system to access donor lists, donation amounts, shares, likes, etc. with respect to the collaborative fundraising event.

The computing device 1602 may be, for example, a server of a service provider, a device associated with a client (e.g., a client device), an on-chip system, and/or any other suitable computing device or computing system. The example computing device 1602 as illustrated includes a processing system 1604, one or more computer-readable media 1606, and one or more I/O interfaces 1608 that are communicatively coupled, one to another. Although not shown, the computing device 1602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1604 is representative of functionality to perform one or more operations using hardware. Accordingly, the processing system 1604 is illustrated as including hardware elements 1610 that may be configured as processors, functional blocks, and so forth. This may include implementation in hardware as an application specific integrated circuit or other logic device formed using one or more semiconductors. The hardware elements 1610 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1606 is illustrated as including memory/storage 1612. The memory/storage 1612 represents memory/storage capacity associated with one or more computer-readable media. The memory/storage component 1612 may include volatile media (such as random access memory (RAM)) and/or nonvolatile media (such as read only memory (ROM), Flash memory, optical disks, magnetic disks, and so forth). The memory/storage component 1612 may include fixed media (e.g., RAM, ROM, a fixed hard drive, and so on) as well as removable media (e.g., Flash memory, a removable hard drive, an optical disc, and so forth). The computer-readable media 1606 may be configured in a variety of other ways as further described below.

Input/output interface(s) 1608 are representative of functionality to allow a user to enter commands and information to computing device 1602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 1602. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 1602, such as via a network. Computer-readable transmission media typically may transmit computer-readable instructions, data structures, program modules, or other data in a modulated data signal, such as carrier waves, data signals, or other transport mechanism. Computer-readable transmission media also includes any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 1610 and computer-readable media 1606 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1610. The computing device 1602 may be configured to implement particular instructions and/or functions corresponding to the software and/or hardware modules. Accordingly, implementation of a module that is executable by the computing device 1602 as software may be achieved at least partially in hardware, e.g., through use of computer-readable storage media and/or hardware elements 1610 of the processing system 1604. The instructions and/or functions may be executable/operable by one or more articles of manufacture (for example, one or more computing devices 1602 and/or processing systems 1604) to implement techniques, modules, and examples described herein.

The techniques described herein may be supported by various configurations of the computing device 1602 and are not limited to the specific examples of the techniques described herein. This functionality may also be implemented all or in part through use of a distributed system, such as over a “cloud” 1614 via a platform 1616 as described below.

The cloud 1614 includes and/or is representative of a platform 1616 for resources 1618. The platform 1616 abstracts underlying functionality of hardware (e.g., servers) and software resources of the cloud 1614. The resources 1618 may include applications and/or data that can be utilized while computer processing is executed on servers that are remote from the computing device 1602. Resources 1618 can also include services provided over the Internet and/or through a subscriber network, such as a cellular or Wi-Fi network.

The platform 1616 may abstract resources and functions to connect the computing device 1602 with other computing devices. The platform 1616 may also be scalable to provide a corresponding level of scale to encountered demand for the resources 1618 that are implemented via the platform 1616. Accordingly, in an interconnected device embodiment, implementation of functionality described herein may be distributed throughout multiple devices of the system 1600. For example, the functionality may be implemented in part on the computing device 1602 as well as via the platform 1616 which may represent a cloud computing environment 1614.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
publishing content associated with a collaborative fundraising event via a social networking system, the collaborative fundraising event associated with a first account and a second account, the first account and the second account having an organizer status with the collaborative fundraising event;
receiving, from a third account, first support for the collaborative fundraising event;
sending, based at least in part on a relationship between the third account and the second account, a notification associated with the first support to the second account;
receiving, from the second account and in association with the notification, a request to transmit a recognition response to the third account based in part on the first support; and
in response to receiving the request, sending the recognition response to the third account.

2. The method as recited in claim 1, further comprising presenting, in association with the third account, content associated with the collaborative fundraiser event, the content including a first indicator attributing the collaborative fundraiser event to the first account and a second indicator attributing the collaborative fundraiser event to the second account.

3. The method as recited in claim 1, further comprising providing at least one tool to the second account to generate the recognition response associated with the first support.

4. The method as recited in claim 3, wherein the at least one tool generates a template recognition response based at least in part on at least one of:
content associated with the collaborative fundraising event,
first data associated with the first support, or
second data associated with the third account.

5. The method as recited in claim 1, wherein the collaborative fundraising event is associated with a fourth account of the social networking system and the fourth account having a beneficiary status with the collaborative fundraising event; and
the method further comprises determining that the first support meets or exceeds at least one threshold; and based at least in part on the first support meeting or exceeding the at least one threshold, sending a notification associated with the first support to the fourth account.

6. The method as recited in claim 5, further comprising:
providing at least one tool to the fourth account to generate a beneficiary recognition response associated with the first support;
receiving, in association with the fourth account, the beneficiary recognition response for delivery to the third account; and
sending to the fourth account the beneficiary recognition response.

7. The method as recited in claim 1, wherein sending the recognition response to the third account further comprises publishing the recognition response in association with the collaborative fundraiser event.

8. The method as recited in claim 1, further comprising:
receiving, from a fifth account, second support for the collaborative fundraising event; and
generating, for the second account, an aggregated recognition response associated with the first support and the second support;
sending, to a fifth account, the aggregated recognition response; and
wherein sending the recognition response to the third account includes sending the aggregated recognition response.

9. One or more non-transitory computer-readable media storing instructions that, when executed by one or more processors, cause one or more computing devices to perform operations comprising:
publishing content associated with a collaborative fundraising event via a social networking system, the collaborative fundraising event associated with a first account, a second account, and a third account of the social networking system;
receiving, from the fourth account, first support for the collaborative fundraising event;
sending, based at least in part on a relationship between the fourth account and the second account, a notification associated with the first support to the second account;
receiving, from the second account and in association with the notification, a request to transmit a recognition response to the fourth account based in part on the first support; and
in response to receiving the request, sending the recognition response to the fourth account.

10. The one or more non-transitory computer-readable media as recited in claim 9, wherein the first account and the second account having an organizer status with the collaborative fundraising event and the third account having a beneficiary status with the collaborative fundraising event.

11. The one or more non-transitory computer-readable media as recited in claim 9, further comprising determining that the first support meets or exceeds at least one threshold; and based at least in part on the first support meeting or exceeding the at least one threshold, sending a notification associated with the first support to the third account.

12. The one or more non-transitory computer-readable media as recited in claim 11, wherein the operations further comprise:
providing at least one tool to the third account to generate a beneficiary recognition response associated with the first support; and
sending to the fourth account the beneficiary recognition response.

13. The one or more non-transitory computer-readable media as recited in claim 9, wherein the at least one tool provides, to the second account, a first selectable link to generate a private message to the fourth account and a second selectable link to provide a public indication of appreciation for the support.

14. The one or more non-transitory computer-readable media as recited in claim 9, wherein sending to the fourth account the recognition response further comprises publishing the recognition response in association with the collaborative fundraiser event.

15. A social networking system comprising:
one or more processors; and
one or more computer-readable media storing instructions that, when executed by the one or more processors, cause the one or more processors to perform operations comprising:
publishing content associated with a collaborative fundraising event via a social networking system, the collaborative fundraising event associated with a first account, a second account, and a third account of the social networking system;
receiving, from the fourth account, first support for the collaborative fundraising event;
sending, based at least in part on a relationship between the fourth account and the second account, a notification associated with the first support to the second account;
receiving, from the second account and in association with the notification, a request to transmit a recognition response to the fourth account based in part on the first support; and
in response to receiving the request, sending the recognition response to the fourth account.

16. The social networking system as recited in claim 15, wherein the operations further comprise:
sending, based at least in part on the first support meeting or exceeding at least one threshold, a notification associated with the first support to the third account;
providing at least one tool to the third account to generate a beneficiary recognition response associated with the first support; and
sending to the fourth account the beneficiary recognition response.

17. The social networking system as recited in claim 15, wherein the operations further comprise:
receiving, from a fifth account, second support for the collaborative fundraising event;
generating, for the second account, an aggregated recognition response associated with the first support and the second support;
sending to the firth account the aggregated recognition response; and
wherein sending to the fourth account the recognition response includes sending the aggregated recognition response.

18. The social networking system as recited in claim 15, wherein the first account and the second account having an organizer status with the collaborative fundraising event and the third account having a beneficiary status with the collaborative fundraising event.

19. The social networking system as recited in claim 15, wherein the at least one tool provides, to the second account, a first selectable link to generate a private message to the fourth account and a second selectable link to provide a public indication of appreciation for the support.

20. The social networking system as recited in claim 15, wherein sending to the fourth account the recognition response further comprises publishing the recognition response in association with the collaborative fundraiser event.
